(19) United States
(12) Patent Application Publication
(10) Pub. No.: US 2020/0009876 A1
(43) Pub. Date: Jan. 9, 2020

(54) METHOD FOR DETECTING DEFECTIVE PRINTING NOZZLES USING TWO-DIMENSIONAL PRINTING NOZZLE TEST CHARTS

(71) Applicant: HEIDELBERGER DRUCKMASCHINEN AG, Heidelberg (DE)

(72) Inventors: STEFFEN NEEB, BENSHEIM (DE); NICKLAS RAYMOND NORRICK, HEDDESHEIM (DE); ANDREAS HENN, NECKARGEMUEND (DE); JENS FORCHE, MANNHEIM (DE)

(21) Appl. No.: 16/504,373

(22) Filed: Jul. 8, 2019

(30) Foreign Application Priority Data
Jul. 6, 2018 (DE) 10 2018 211 172.3

(51) Int. Cl. B41J 2/21; B41J 29/393

(52) U.S. Cl. CPC B41J 2/2142; B41J 2029/3935; B41J 29/393

(57) ABSTRACT

A method detects defective printing nozzles in an inkjet printing machine by a computer. The method includes printing a printing nozzle test chart for detection purposes, recording the printing nozzle test chart by use of at least one image sensor, and analyzing the recorded printing nozzle test chart by the computer to identify defective printing nozzles. To create the printing nozzle test chart, every printing nozzle prints a surface, and the computer determines the centroid of every surface to analyze the recorded printing nozzle test chart and for all surfaces compares the actual position of the determined centroid to the respective target position.

### CROSS-REFERENCE TO RELATED APPLICATION

This application claims the priority, under 35 U.S.C. § 119, of German application DE 10 2018 211 172.3, filed Jul. 6, 2018; the prior application is herewith incorporated by reference in its entirety.

### BACKGROUND OF THE INVENTION

### Field of the Invention

The present invention deals with a method for detecting defective printing nozzles using two-dimensional printing nozzle test charts.

The technical field of the invention is the field of inkjet printing.

A problem that may occur in inkjet printing machines is that printing nozzles may fail or be switched off because specific characteristic values exceed defined tolerances. In both cases, defects in the print may occur, for instance what are known as white lines in a solid area. To be able to classify the individual printing nozzles, detection charts need to be inserted at specified intervals in a printing operation. These are then assessed in a nozzle-related way to decide whether a printing nozzle will be switched off or on again.

Various test charts are known in the art. A common printing nozzle test chart looks as follows: every printing nozzle prints a vertical line and the vertical lines are arranged in such a way in the detection chart that they do not overlap and an evaluation is possible. They may take the form of 11 lines or big dots printed in a stair-like formation. Since there is an unequivocal association between printing nozzle number and line, an association is possible. Image processing techniques are then used to determine parameters such as amplitude (ink drop volume) and phase (value of jetting obliqueness).

All characteristic values that are determined today only refer to the transverse direction, i.e. the direction transverse to the printing direction. So far, there are no test charts that provide reliable information on printing nozzle quality in the direction of printing substrate travel. However, the transverse-direction data that are currently available are not sufficient to describe all print quality problems, especially not in terms of white lines. There is a reasonable suspicion that fluctuations of characteristic values in the direction of travel also have a serious impact on print quality.

Thus a disadvantage of the prior art is that all characteristic values that are determined today for individual nozzles only refer to the transverse direction. These transverse-direction data that are available so far are not capable of describing all print quality problems, especially not white lines. Fluctuations of characteristic values in the direction of travel are therefore not taken into account in quality assessment processes that are currently in use.

U.S. patent publication No. 2013/0182029A1 deals with a similar problem, namely that the information that may be obtained from a printing nozzle test chart is not sufficient for a correct detection of defective printing nozzles. The document suggests printing two different printing nozzle test charts: a first printing nozzle test chart printed normally and a second printing nozzle test chart printed using twice the amount of ink. An analysis of the two test charts provides a much more reliable identification of the missing printing nozzles because the known increase of the amount of ink makes printing nozzles with reduced printing performance or printing nozzles that do not print at all much easier to detect. However, this invention does not solve the problem that the characteristic values obtained from printing and analyzing the printing nozzle test charts exclusively refer to the transverse direction. This approach does not provide any way of analyzing test charts in the direction of travel to obtain information on the printing nozzle quality.

### SUMMARY OF THE INVENTION

Thus an object of the present invention is to provide a method for detecting defective printing nozzles in an inkjet printing machine, the method providing reliable information on the print quality of the printing nozzles in the direction of travel and thus being more efficient than the methods known from the prior art.

The object is attained by a method for detecting defective printing nozzles in an inkjet printing machine by a computer containing the steps of printing a printing nozzle test chart for detection purposes, recording the printing nozzle test chart by at least one image sensor, and analyzing the recorded printing nozzle test chart by the computer to identify defective printing nozzles. The method is characterized in that every printing nozzle prints a surface to create the printing nozzle test chart, the computer determines the centroid for an analysis of the recorded printing nozzle test chart and, for all surfaces, compares the actual position of the determined centroid to the respective target position. To provide an analysis of the printing nozzle test chart to determine the characteristic values of the printing nozzles in the direction of travel as proposed by the invention, the printing nozzle test chart needs to be configured in such a way that for every printing nozzle, information is provided not only in the transverse direction, i.e. across the printing direction, but also in the direction of travel, i.e. along the direction of travel of the printing substrate. This is attained in that every printing nozzle prints not just a simple vertical line, but a surface with a two-dimensional expansion, which contains this information not only in the transverse direction, but also in the direction of travel. Then the computer makes the analysis by determining the centroid of every surface in the printed image that has been recorded by the image sensor and thus digitized. The image sensor is usually a camera. If the inkjet printing machine has an inline image recording system for image inspection purposes, this is the camera (system) that is preferably used. The centroid corresponds to the central print dot for every printing nozzle. Since the target print dots and thus in fact the target centroids for every surface in the printing nozzle test chart are known, the actual centroids that have been determined may be compared to the target centroids to determine the desired characteristic values not only in the transverse direction but also in the direction of travel; these characteristic values may then be used to detect defective printing nozzles.

Advantageous and thus preferred further developments of the method will become apparent from the associated dependent claims and from the description together with the associated drawings.

A preferred further development of the method of the invention in this context is that the printing nozzle test chart is created by periodically printing a specific number of horizontal rows of equidistant surfaces disposed underneath one another, wherein in every row of the printing nozzle test chart only those printing nozzles that correspond to the specific number of horizontal rows periodically create surfaces. The printing nozzle test chart is created in the known way, which means that every printing nozzle prints a specific number of horizontal rows of the corresponding test elements as it is known in the prior art. Since only every xth printing nozzle prints in every row, x rows are required per printing nozzle test chart. In contrast to the printing nozzle test charts that are known in the art, the method of the invention creates a printing nozzle test chart that no longer includes individual vertical lines but corresponding surfaces with a centroid.

A further preferred further development of the method of the invention in this context is that the equidistant surfaces that are printed periodically are created by multiple printing operations while the printing substrate is at a standstill. This represents the most efficient way of creating the desired equidistant surfaces because it only requires the generation of an ink drop of a specified size to form the equidistant surface. In contrast to the prior art where vertical lines are created, for this purpose, the printing substrate needs to be at a standstill and must not be moved while the printing nozzle prints. Special printing substrate transport requirements are the result because to print the corresponding printing nozzle test chart, the substrate needs to be stopped and moved again a short distance multiple times. In terms of substrate transport, the inkjet printing machine needs to be equipped to be capable of such a behavior.

A further preferred further development of the method of the invention in this context is that the equidistant surfaces that are periodically printed are created by multiple printing operations at an increased jetting frequency during the production run. In a case in which the required transport of the printing substrate with frequent stops and restarts to create the printing nozzle test chart with the equidistant surfaces is too problematic, the test chart with the equidistant surfaces may alternatively be created when the printing substrate is moved like in a production run. However, to create the equidistant surfaces in such a case, an increased jetting frequency is required to ensure the required multiple printing operations to create the larger ink drops for the equidistant surfaces. Which one of the two approaches (multiple printing operations while the printing substrate is at a standstill or multiple printing operations at an increased jetting frequency during the production run) is used depends on what the printing machine system that is used, i.e. the inkjet printing machine, is more suited for or on what is more in accord with the operator's preferences.

A further preferred further development of the method of the invention in this context is that the determination of the centroid of every surface is achieved by an optimized adaptation of an ellipse to the contour of the surface, with the center of the ellipse representing the centroid. Different approaches are possible to determine the centroid of every surface—a necessary operation for the method of the invention. One of these approaches is to superpose an ellipse over the contour of the surface and to adapt the ellipse in such a way that it delimits the contour of the surface in a corresponding way. When this has been achieved, the center of the ellipse may be calculated. It logically corresponds to the center of the surface. The center of the surface corresponds to the centroid of the surface that is to be determined.

A further preferred further development of the method of the invention in this context is that the determination of the centroid of every surface is achieved by calculating the surface moment of inertia of the surface. An alternative method to determine the centroid of every surface is a corresponding calculation of the surface moment of inertia. Which one of the two methods (calculating the surface moment of inertia or the center of the applied ellipse) is more expedient depends on the characteristics of the corresponding printing operation. It may be possible to use both approaches and then to select the one that yields better results.

A further preferred further development of the method of the invention in this context is that additionally, a weighting by the local density distribution above the print dot of the surface is carried out. The calculation of the surface moment of inertia may additionally be improved by a weighting of the local density distribution of the surface above the print dot of the nozzle in question that creates the surface.

A further preferred further development of the method of the invention in this context is that the determination of the centroid of every surface is achieved by an estimate of the frequency distribution of the local density distribution above the print dot, assuming a two-dimensional normal distribution for the estimate of the frequency distribution. The determination of the centroid by statistical methods such as the aforementioned estimate of the frequency distribution of the local density distribution above the print dot is a further approach to determining the centroid of every surface.

A further preferred further development of the method of the invention in this context is that distribution coefficients of the centroid are taken into consideration when the centroid of every surface is determined. Since the corresponding centroids of every surface in the printing nozzle test chart may vary for every printing nozzle, i.e. a printing nozzle may have a different centroid in a first printing nozzle test chart than in a following printing nozzle test chart, it makes sense to take the centroid history into consideration on the basis of previous printing nozzle test charts and to take the distribution coefficients that have been obtained in this way into consideration in a corresponding way when the comparison with the target centroids is made. Such an assessment of the corresponding characteristic values both in the transverse direction and in the direction of travel is more reliable than an assessment that is only based on a comparison of the respective current centroid of the respective current printing nozzle test chart.

The invention as such as well as further developments of the invention that are advantageous in constructional and/or functional terms will be described in more detail below with reference to the associated drawings and based on at least one preferred exemplary embodiment. In the drawings, mutually corresponding elements have the same reference symbols.

Other features which are considered as characteristic for the invention are set forth in the appended claims.

Although the invention is illustrated and described herein as embodied in a two-dimensional printing nozzle test charts, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side view of a sheet-fed inkjet printing machine;

FIG. 2 is an illustration of a schematic example of a white line caused by a missing nozzle;

FIG. 3 is an illustration of an example of a test chart with vertical lines;

FIG. 4 is an illustration of an example of a test chart with surface objects; and

FIG. 5 is an illustration of a surface object and a determination of a centroid of an ellipse.

### DETAILED DESCRIPTION OF THE INVENTION

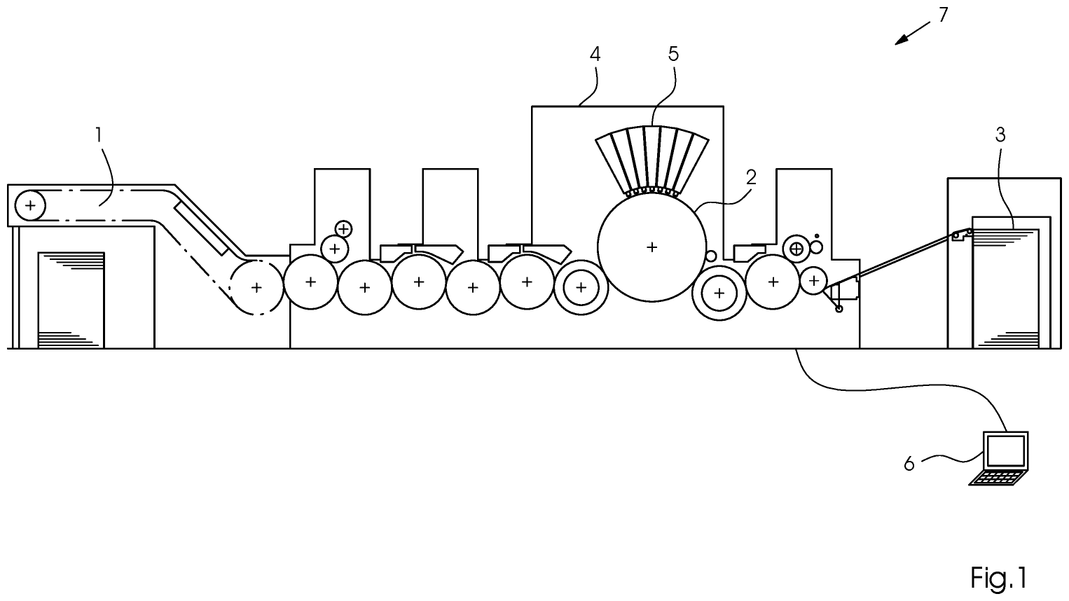

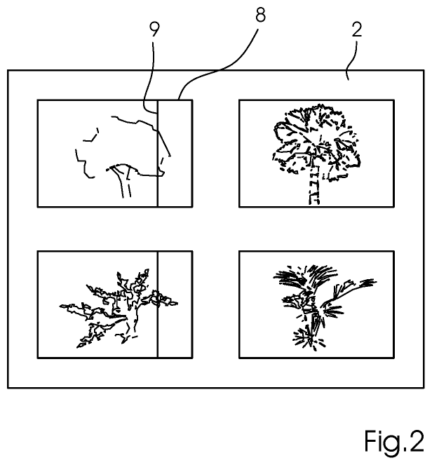

Referring now to the figures of the drawings in detail and first, particularly to FIG. 1 thereof, there is shown a field of application of a preferred exemplary embodiment of an inkjet printing machine 7. FIG. 1 shows an example of the fundamental design of the inkjet printing machine 7, including a feeder 1 for feeding a printing substrate 2 to a printing unit 4, where it receives an image printed by print heads 5, and a delivery 3. The printing machine 7 is a sheet-fed inkjet printing machine 7 controlled by a control unit 6. While the printing machine 7 is in operation, individual printing nozzles in the print heads 5 in the printing unit 4 may fail as described above. Such a failure results in white lines 9 or, in the case of multicolor printing, in distorted color values. An example of such a white line 9 in a printed image 8 is shown in FIG. 2.

The method of the invention aims at using a test chart 12 that provides information both in the transverse direction and in the direction of travel to determine characteristic values of printing nozzles. In accordance with the invention, such a test chart 12 is created as follows:

The substrate 2 is not moved relative to the print head 5 during the printing operation, i.e. it is at a standstill.

Every printing nozzle prints multiple times within a very short period of time. What is referred to as an “S drop” is generated in every printing operation. In this process, the printing nozzles are actuated in a way to ensure that they do not overlap to provide evaluability. For instance, if every 10th printing nozzle is used, the printing nozzle test chart 12 needs to be printed a total of ten times. In between the individual printing operations, the substrate 2 is moved in a corresponding way. It is possible for all printing nozzles to print without moving the web. However, this is dependent on the geometry of the print head.

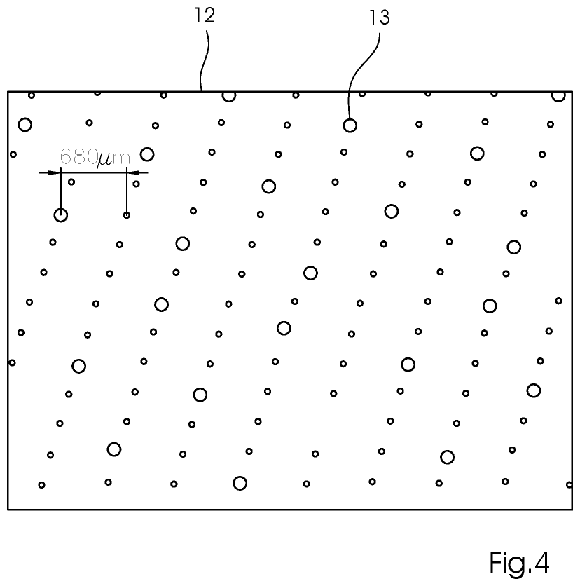

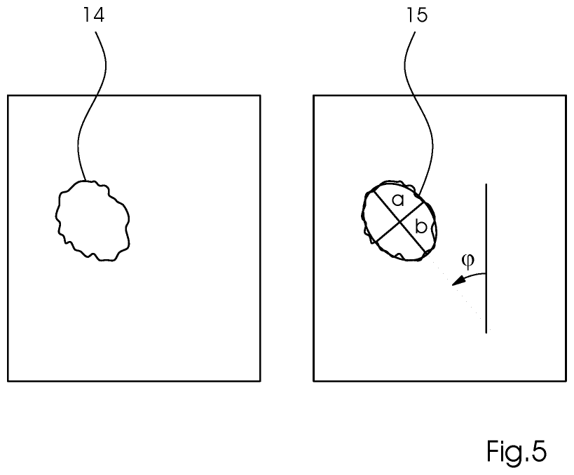

FIG. 4 illustrates an example of such a print. In this example, only the thicker dots/drops 13 are to be taken into consideration because only these pertain to one and the same printing nozzle that printed multiple times. The smaller dots were created as a result of scattering—they would not be present in the completed test chart 12. Therefore, this is only to be understood as an example; in the final test chart 12, all printing nozzles would accordingly have printed multiple times. Thus in FIG. 4, every dot 13 corresponds to a printing nozzle, irrespective of whether it is small or big. In addition, all dots 13 in FIG. 4 have “coffee stain” contours 14. This is shown in more detail in FIG. 5. However, this has no negative effect on the method of the invention.

The printing nozzle test chart 12 is evaluated by the computer 6 or in a computer-assisted way as follows: Drops 13 are allocated to nozzle numbers by counting. The geometry of the print head and therefore the target distances in the x and y directions are known. Missing nozzles may be taken into consideration in this process by simple computing operations.

Every drop 13, as a result of multiple printing operations in one and the same location, is evaluated in geometric terms. This may be done in accordance with the following approaches:

Optimized adaptation of an ellipse to the contour 15 by what is known as curve fitting. The center of the ellipse is the central position in the x and y directions. Based on its angular position in the plane and the lengths of the respective semi-axes, the ellipse provides an approximation of distribution coefficients in the x and y directions.

For every print dot, the centroid and surface moment of inertia are calculated in the x and y directions. This likewise corresponds to an x, y position value and x, y distribution coefficients. Moreover, a weighting by the local density distribution above the print dot could be done.

For every print dot, the frequency distribution could be estimated on the basis of the local density distribution above the print dot. For this purpose, a 2D normal distribution might be used. This likewise corresponds to an x, y position value and x, y distribution coefficients.

For every drop, the computer 6 compares the actual position to the target position in the printing nozzle matrix. For this purpose, several approaches are known and are already in use for current printing nozzle test charts 10.

On the left-hand side, FIG. 5 illustrates an example of a surface 14 with a corresponding contour (“coffee stain”) in a test chart 12 of the invention. On the right-hand side, the same surface is shown with an ellipse optimally adapted to the contour 15 in accordance with approach a). The semi-axes and angles can be clearly seen.

All restrictions that apply to known printing nozzle test charts 10 in terms of substrate and color dependence, for instance, also apply to the printing nozzle test chart 12 including surfaces 13 in accordance with the invention. The question of which manifestations of these characteristic values lead to a reduced printing quality needs to be addressed in the same way as it needs to be addressed with the known printing nozzle test charts 10. This means that the respective thresholds for the specific characteristic values, namely when the printing nozzle creates a white line 9, for instance, need to be determined.

In an alternative embodiment, the printing nozzle test chart 12 of the invention may be created during the production run. Ideally, the jetting frequency would be set to the maximum for this test chart 12; the maximum frequency ranges between 46 kHz and 100 kHz.

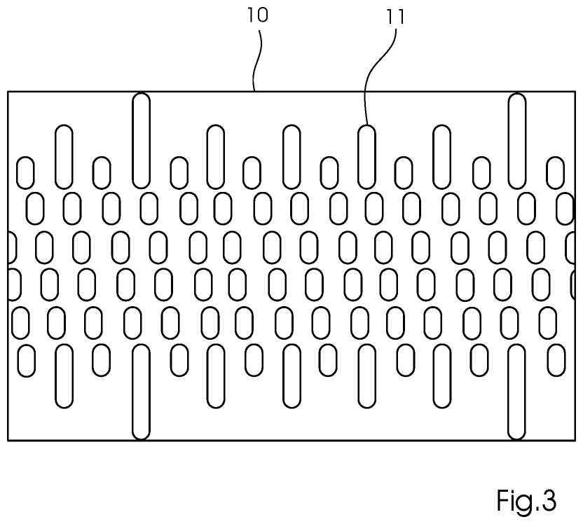

This minimizes how far the test chart stretches in the direction of travel. Thus the test chart 12 may still be printed in a compact way and negative effects caused by sheet/web travel are minimized. In contrast, without a jetting frequency increase, the test chart 12 would look similar to the test chart 10 with nozzle ruler that is common today. Such a standard test chart 10 is shown by way of example in FIG. 3. In the example, each one of the small vertical lines 11 was created by 4 drops.

For this alternative embodiment, the applied evaluation strategy may be analogous with the one that is applied in the case of the test chart 12 that is created when the substrate is at a standstill. The statements on the evaluation that were made in the above context also apply to this embodiment.

An advantage of the method of the invention and the printing nozzle test chart 12 over the prior art is that all characteristic values that are determined for the individual printing nozzles no longer exclusively refer to the transverse direction (x direction), but also to the direction of travel of the printing substrate 2 (y direction). This means that it is now possible to describe printing quality problems that are dependent on the direction of travel, in particular white lines 9. This in general refers to characteristic value variation in the direction of travel, for example. The method of the invention provides a respective position value and distribution coefficient both in the x direction and in the y direction.

However, care should be taken to ensure that the resolution of the camera that is used to record the test chart 12 is sufficiently high. In particular if an inline image recording system is used to inspect the image and analyze image quality, the resolution of the camera of the inline system is often not sufficient.

The following is a summary list of reference numerals and the corresponding structure used in the above description of the invention:
1 feeder
2 current printing substrate/current print sheet
3 delivery
4 inkjet printing unit
5 inkjet print head
6 computer
7 inkjet printing machine
8 image on the current print sheet
9 white line
10 standard printing nozzle test chart with vertical lines
11 vertical printing nozzle line in the test chart
12 printing nozzle test chart with surfaces in accordance with the invention
13 surface in the printing nozzle test chart
14 individual surface with “coffee stain” contour
15 individual surface with ellipse that has been optimally adapted to the contour

1. A method for detecting defective printing nozzles in an inkjet printing machine by means of a computer, which comprises the steps of:
printing a printing nozzle test chart for detection purposes, wherein to create the printing nozzle test chart, every printing nozzle prints a surface;
recording the printing nozzle test chart by means of at least one image sensor; and
analyzing a recorded printing nozzle test chart by means of the computer to identify the defective printing nozzles, the computer determining a centroid of every said surface to analyze the recorded printing nozzle test chart and, for all surfaces, the computer compares an actual position of a determined centroid to a respective target position.

2. The method according to claim 1, wherein the printing nozzle test chart is created in that a specified number of horizontal rows of equidistant surfaces that are disposed underneath one another are printed periodically and wherein in every row of the printing nozzle test chart, periodically only the printing nozzles that correspond to the specified number of the horizontal rows create the surfaces.

3. The method according to claim 2, which further comprises creating the equidistant surfaces that are periodically printed by multiple printing operations while the printing substrate is at a standstill.

4. The method according to claim 2, which further comprises creating the equidistant surfaces that are periodically printed by multiple printing operations at an increased jetting frequency during a production run.

5. The method according to claim 1, which further comprises carrying out a determination of the centroid of every said surface by optimally adapting an ellipse to a contour of the surface, wherein a center of the ellipse represents the centroid.

6. The method according to claim 1, which further comprises achieving a determination of the centroid of every said surface by calculating a surface moment of inertia of the surface.

7. The method according to claim 6, which further comprises implementing a weighting by a local density distribution above a print dot of the surface.

8. The method according to claim 1, which further comprises implementing a determination of the centroid of every said surface by estimating a frequency distribution of a local density distribution above a print dot, wherein a two-dimensional normal distribution is assumed for an estimate of the frequency distribution.

9. The method according to claim 5, wherein distribution coefficients of the centroid are taken into consideration when the centroid of every said surface is determined.
